(19) United States
(12) Patent Application Publication
(10) Pub. No.: US 2005/0103141 A1
(43) Pub. Date: May 19, 2005

(54) Transmission of an automobile

(76) Inventor: Myoung Hun Kang, Suwon-city (KR)

Correspondence Address: MORGAN, LEWIS & BOCKIUS LLP (SF), 2 PALO ALTO SQUARE, PALO ALTO, CA, 94306, US

(21) Appl. No.: 10/962,028

(22) Filed: Oct. 8, 2004

(30) Foreign Application Priority Data
Nov. 17, 2003 (KR) 10-2003-0081014

(51) Int. Cl. F16H 57/02

(52) U.S. Cl. 74/458

(57) ABSTRACT

A shaft of a transmission is supported by a housing member via first and second bearing members. A driven gear rotates the shaft and a drive gear that delivers rotation of the shaft and the drive gear to a differential gear. The gears are disposed at locations between a first and a second bearing member on the shaft.

### CROSS-REFERENCE TO RELATED APPLICATION

This application claims priority of Korean Application No. 10-2003-0081014, filed Nov. 17, 2003, the disclosure of which is incorporated herein by reference.

### TECHNICAL FIELD OF THE INVENTION

The present invention relates to a shaft support structure of a transmission. More specifically, a mounting characteristic is based on transmission length reduction by directly supporting the transmission case at both ends of the transmission shaft using a bearing member.

### BACKGROUND OF THE INVENTION

Generally, a transmission is furnished with a speed change gear mechanism. The speed change gear mechanism typically embodies a required change ratio based on a gear ratio combination from the engine power. The engine power is delivered through a clutch device and a shaft receives the output obtained by the speed change gear mechanism at a driven gear and delivers it to a differential gear through a drive gear. Therefore, a driven gear is typically mounted on a shaft that receives power from a speed change gear mechanism and rotates a shaft and a drive gear as one body.

The driven gear and drive gear generally employ helical gears to increase power delivery efficiencies. When power is delivered through a speed change gear mechanism. A forward drive condition occurs when drive torque is applied to a driven gear and a reverse drive condition exists when drive torque, from the wheel side, is applied to a drive gear through a differential gear during downward slope driving or inertia driving prior to stopping. In such cases, the biasing force incurred by pulley combination of a helical gear is exerted on a bearing member that supports both ends of the shaft. Such a biasing force strongly presses the bearing member so that the possibility of separation of the bearing from the shaft increases.

Therefore, additional members have been included, including a bearing member retainer and a locking nut. These members have been used to support the bearing members and prevent the bearing member from breaking away. However, these supports has caused a deterioration of the mounting characteristic inside an engine room due to an increase in the entire transmission length. In particular, if the locking nut is mounted, processes to fabricate screws on a shaft, perform caulking to prevent loosening of the fastened nut, etc. must also be accompanied. This increases manufacturing cost and time required to manufacture and assemble the components.

### SUMMARY OF THE INVENTION

According to a preferred embodiment, the present invention provides a shaft support structure of a transmission that can enhance the mounting characteristic by transmission length reduction and lower the processing and manufacturing costs.

Preferably, the shaft support structure includes a housing member that includes a case of a transmission and a shaft. Both ends of the shaft are supported by the housing member so as to allow rotational motion with a first bearing member and a second bearing member. Also, a driven gear and a drive gear are mounted on the shaft to receive or deliver power.

It is preferred that the driven gear and the drive gear are both helical gears, and it is desirable that the helix of the driven gear and the helix of the drive gear are formed in the same direction. It is also desirable that the helix of the driven gear is formed in the opposite direction to that of the shaft rotation at the forward shift of the transmission.

### BRIEF DESCRIPTION OF THE DRAWINGS

For better understanding of the nature and objects of the invention, reference should be made to the following detailed description, taken in conjunction with the accompanying drawings, in which:

FIG. 1 is a cross-sectional view illustrating a structure of a shaft support of a transmission according to an embodiment of the present invention; and

FIG. 2 illustrates a helix directions of a driven gear and a drive gear of a shaft according to an embodiment of the present invention.

### DETAILED DESCRIPTION OF THE PREFERRED EMBODIMENTS

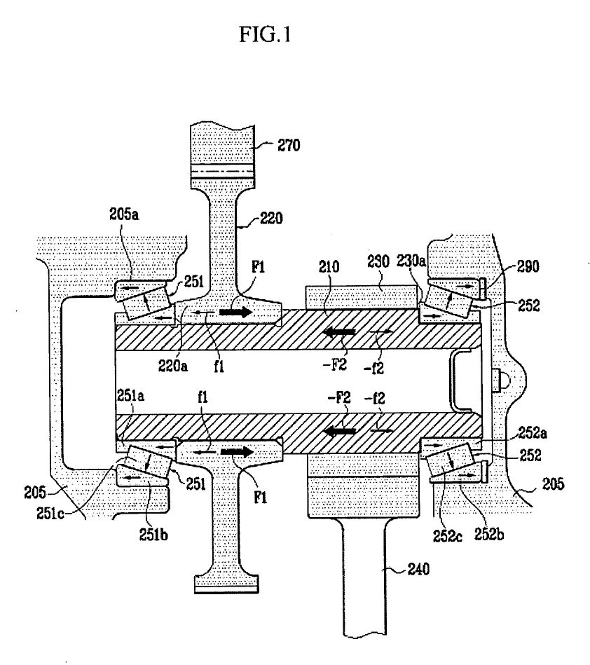

FIG. 1 shows a cross-sectional illustration of the structure of a shaft support of a transmission. As illustrated, the shaft support structure of a transmission includes a housing member 205, a first bearing member 251, and a second bearing member 252 that are directly supported by the housing member 205 on one side. A shaft 210 is also supported by the housing member 205 at both ends through the bearing members 251, 252. A driven gear 220 and a drive gear 230 are deployed on the shaft so that they can be separated from each other and respectively support other sides of the bearing members 251, 252.

Between the housing member 205 and bearing member 252 is installed a spacer 290 so that a bearing member may adhere closely and operate smoothly. Tolerance, and the like, that may be generated during manufacturing may be absorbed by this spacer 290. The said bearing members 251, 252 are housed in inner cases 251a, 252a, outer cases 251b, 252b, and rollers 251c, 252c. While the outer cases are supported by a step jaw 205a of the housing member 205, the inner cases 251a, 252a are supported by base parts 220a, 230a of gears 220, 230. Rollers 251c, 252c are installed between the inner cases and the outer cases such that installation directions are inclined downwardly toward both ends of the shaft 210 at a certain angle. Additionally, the driven gear 220 receives power through a speed change gear mechanism within the transmission to rotate the shaft 210 and the drive gear 230, while the drive gear 230 is set to deliver rotational force to a differential gear 240.

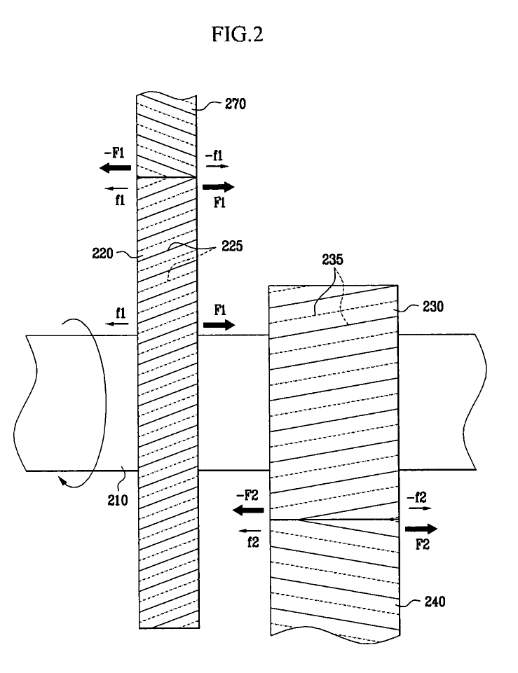

On the other hand, the driven gear 220 and the drive gear 230 are respectively embodied as helical gears, and helixes of the gears 220, 230 are formed preferably in the same direction. The helixes formed on the driven gear 220 and drive gear 230 are described in detail referring to FIG. 2.

FIG. 2 illustrates the helix directions of the driven gear 220 and the drive gear 230 of the shaft 210 in the transmission according to an embodiment of the present invention. More specifically, the helixes of the driven gear 220 and the drive gear 230 desired when a shaft 210 rotates in a clockwise direction viewed from the left side at forward speed gears including 1-speed, 2-speed, and 3-speed.

According to FIG. 2, the helix 225 of the driven gear 220 is formed in a counter-clockwise direction moving to the right in the Figure. In other words, the helix 225 of the driven gear 220 is formed in the direction opposite to the rotation direction of the shaft 210 moving to the right in the Figure. The right side of FIG. 2 is the direction that faces the drive gear 230 side from the driven gear 220. Therefore, to summarize the above, a driven gear 220 forms its helix in the direction (namely, counter-clockwise direction) opposite to the rotational direction (namely, clockwise direction) of the shaft 210 moving in the direction from the driven gear 220 to the drive gear 230. The helix 235 of the drive gear 230 is formed in a counter-clockwise direction moving to the right in FIG. 2 as for the helix 225 of the driven gear 220.

A number of advantages are realized with the drive gear 230 and the driven gear 220 being mounted on the shaft 210 between the locations of first and second bearing members 251, 252, and by the directionality of the helixes 225, 235.

First, the case is examined in which power of an engine is subject to changing speed and producing output. If power of an engine is subject to changing speed by a speed change mechanism 270 and delivered to a driven gear 220 on a shaft 210, the driven gear 220 becomes subject to a biasing force F1 in the right direction of FIG. 2 by directionality of the helix 225. Therefore, such a bearing force F1 is delivered to the shaft 210 in the right direction of FIG. 2.

On the other hand, a rotation force of the driven gear 220 is delivered to the drive gear 230 through the shaft 210, whereas a rotation force of the drive gear 230 is delivered to a differential gear 240. Here, between the drive gear 230 and the differential gear 240, a biasing force takes place mutually by directionality of the helix.

In other words, the drive gear 230 applies a biasing force F2 to a differential gear 240 in a right direction of FIG. 2, while rotating the differential gear 240. By its reaction, a biasing force −F2 is also applied from a differential gear 240 to the drive gear 230 as a reacting force, and such a biasing force −F2 is delivered to a shaft 210. Here, the biasing force F1 formed at the driven gear 220 and the biasing force F2 formed at the drive gear 230 are the same in magnitude and opposite to each other in direction.

Therefore, the biasing force F1 in the right direction of FIG. 2 and the biasing force −F2 in the left direction are offset with each other on the shaft 210, so overall rotation may be facilitated without straining first and second bearing members 251, 252.

As in the case of coasting in a neutral gear, the transmission does not change the speed for engine power, and if a reacting force of the ground is received, slight biasing forces f1, −f2 are formed at the driven gear 220 and the drive gear 230 by the reacting force of the road surface. In such a case, the reactive biasing force of the driven gear 220 applies to the first bearing member 251 only, while the reactive biasing force of the drive gear 230 applies to the second bearing member 252 only. Therefore, as the first and second bearing members 251, 252 only need to distribute the biasing force that each is responsible for alone, the load applied to the bearing members is distributed.

While preferred embodiments of the present invention have been described, this invention is not intended to be limited by the disclosure, but cover modifications and alterations obvious to one of ordinary skill in the art that are encompassed by the appended claims.

According to embodiments of the present invention, if power of an engine is allowed to change speed and produce output, biasing forces are offset with each other on a shaft of the transmission such that power delivery efficiencies and durability of the transmission are improved. Additionally, the parts required for a power delivery mechanism of such a transmission are minimized, so the weight of a transmission may be reduced and as a result, fuel consumption of a vehicle may be improved. Furthermore, loads that the mechanical parts near the shaft are responsible for may be reduced under various driving conditions.

1. A shaft support structure of a transmission, comprises:
a transmission case;
a shaft directly supported by a housing member to allow rotation at both ends of said shaft with bearing members; and
a drive gear and a driven gear disposed such that one side may touch each of said bearing members on said shaft.

2. The shaft support structure of a transmission according to claim 1, wherein said driven gear and said drive gear are helical gears, and helixes of the gears are formed in the same direction.

3. The shaft support structure of a transmission according to claim 2, wherein the helix of said driven gear is formed in a direction opposite to a direction of rotation of said shaft during forward driving.

4. The shaft support structure of a transmission according to claim 1, wherein said bearing member has a roller disposed between an inner case and an outer case, and said roller is mounted such that it is inclined downwardly toward both ends of said shaft.

5. The shaft support structure of a transmission according to claim 4, wherein said bearing member is supported by a gear base part at one side of its inner case and one side of an outer case is supported by a housing member.

6. The shaft support structure of a transmission according to claim 5, wherein said outer case is supported by a step jaw formed at the housing member.

7. The shaft support structure of a transmission according to claim 4, wherein the inner and outer cases of said bearing member are formed as one body.

8. The shaft support structure of a transmission according to claim 1, wherein said drive gear and said driven gear are independently installed on the shaft, and at least one pair is installed.

9. The shaft support structure of a transmission according to claim 1, further comprising a spacer installed between said housing member and said bearing member.

10. A shaft support structure for a transmission, comprising:
a transmission case;
inner bearing members, disposed on opposite ends of the shaft, wherein said inner bearing members are supported against inward movement along said shaft by stepped portions on the shaft; and
outer bearing members cooperating with the inner bearing members, wherein the outer bearing members are directly supported by the transmission housing.

11. The shaft support structure of claim 10, wherein stepped portions are formed on the shaft.

12. The shaft support structure of claim 10, wherein stepped portions are formed respectively by drive and driven gears.

13. The shaft support structure of claim 10, wherein outer bearing members at one end of said shaft are further supported by a spacer for limiting tolerance variations.

14. The shaft support structure of claim 13, wherein the outer bearing member supported by said spacer is disposed at an end of the shaft adjacent the drive gear.
